(19) United States
(12) Patent Application Publication
(10) Pub. No.: US 2008/0209945 A1
(43) Pub. Date: Sep. 4, 2008

(54) Method and apparatus for fusing carbon containing artifacts in glass

(76) Inventor: Patricia Blevins, Federal Way, WA (US)

Correspondence Address: PATRICK M. DWYER PC;#322, 14419 GREENWOOD AVENUE N, SEATTLE, WA, 98133, US

(21) Appl. No.: 11/713,552

(22) Filed: Mar. 3, 2007

(51) Int. Cl. C03B 23/20

(52) U.S. Cl. 65/42

(57) ABSTRACT

Cremated ashes or other carbon containing artifacts are displayed between layers of glass. The method of preparation of the display includes taking a layer of glass, preferably dichroic glass, and sprinkling a layer of glass frit along with the artifact onto the first glass layer. The sprinkled layer is covered with a second layer of glass, the whole assembly being fused at a temperature of about 1700 degrees Fahrenheit or 927 degrees Celsius. An optional third layer above the second layer of glass adds apparent depth and provides a layer space for fusing in additional artwork or other aesthetics and decorations.

### TECHNICAL FIELD

The invention relates to display of carbon containing artifacts in glass; more particularly, it relates to method and apparatus for display of carbon containing artifacts by fusing in layers of glass; more particularly it relates to method and apparatus for display of cremated remains by fusing in layers of glass.

### BACKGROUND OF THE INVENTION

Since time immemorial people have desired to preserve artifacts of departed and beloved humans and animals. Many such artifacts are of a carbon based composition. One of the most common carbon containing artifacts is the cremated remains of the individual, where the body mass has been reduced to ashes. In recent times, various methods of displaying these ashes, such that they may actually be visible to the eyes, have been developed.

One such method is to apply the cremation remains upon an adhesive that has been layered over an artistic substrate for the purposes of presentation. The ashes are then tapped into the adhesive and the adhesive allowed to dry. This may be covered by a glass plate as in the framing of a painting.

Another method is to sprinkle the ashes over one layer of a liquid plastic substance, such as lucite, and pour another layer of liquid plastic over it, which is allowed to harden at room temperature.

Note that, in the methods discussed above, the ashes cannot be manipulated after application to the sticky adhesive or liquid plastic substrate. Also, the ashes may not all adhere to the adhesive and some may fall off during further handling, and the ashes may be displaced from the original composition when the next layer of liquid plastic is poured over the top.

Another method is to create a container with a clear top or front for viewing the ashes. One such container is an ash silhouette display panel with an indentation in the shape of a silhouette of the human or animal to contain the ashes. The ashes are pressed into the indentation in the back panel and a generally translucent front panel is used to seal them in place. This assembly is not truly secure as it may be disassembled and the ashes lost.

Other processes involve mixing the ashes with other moldable substances and casting them to create a sculpture. In one such process the ashes are ground, calcined and oxidized through further heating to create a white substance free from organic and carbon components. The resulting residue is then mixed with glass frit, melted, cast and annealed to form solid objects. In this process, the original cremated ash is ground, oxidized and homogenized beyond the capacity to be recognized any longer as cremated remains.

One method of layering glass and fusing the layers to create artwork is to fuse an artistic pattern of glass strings and chips together and then fuse the pattern to a base glass sheet in several heating steps. This method does not fuse the glass pattern between glass plates, nor incorporate any non-glass materials.

In prior art attempts to incorporate foreign materials into the final glass mass product, one recurring problem is that bubbles appear within the glass mass particularly around the foreign material, especially if the artifacts contain carbon, as do the artifacts contemplated herein.

None of the previous methods of display of cremation ashes or other carbon containing artifacts provide for fusing the ashes safely within glass in such a manner as to leave them recognizable as ashes and visible to the eye. Several methods do not allow for the artistic manipulation of the ashes once they are initially applied to the display surfaces. Some methods, such as pressing them into an indentation and then covering them with a translucent plate like a picture, allow for the removal of the outer protective layer, which would expose the ashes to loss or destruction. Some methods, such as mixing the ash with other hardenable substances for forming into a sculpture, require processing the ash beyond recognition and essentially obscuring it from view.

What is needed is an apparatus and method whereby ashes or other carbon containing artifacts can be safely and permanently fused within glass, without unsightly bubbles, and still be visible and recognizable as ashes. A process is needed where the application of ashes can be manipulated and further arranged during the creation of the display object.

### DISCLOSURE OF THE INVENTION

The apparatus and methods disclosed herein provide a method to preserve and display carbon containing artifacts, such as cremated ashes, where the artifacts can be clearly seen and yet are safely preserved and protected. Advantageously, once the apparatus is created, it cannot be disassembled and the ashes cannot thereafter be disturbed. Using this method, ashes may be displayed in any number of aesthetically pleasing presentations. Because the layer upon which the ash is applied is solid at the time of assembly, the ashes can be arranged and rearranged in the most pleasing aesthetic and artistic display, and further, additional artifacts, decorations or decorative backgrounds may be added to enhance the display. In addition, the disclosed method produces a product generally without gas or air bubbles in the glass.

An advantageous embodiment of the method is to combine a quantity of glass frit with a quantity of the ashes or other carbon containing artifacts and sprinkle the combination over a layer of glass. The sprinkling of glass frit and ashes is then covered by a second layer of glass. Dichroic glass is a preferred material for the solid glass layers. The entire assembly is then fused at a temperature in the range of 1420-1760 degrees Fahrenheit. Advantageously, the temperature is about 1700 degrees Fahrenheit (or about 927 degrees Celsius). One particular advantage of the disclosed method is that it has overcome the problem of bubbles appearing in the glass casing.

The ashes or other carbon containing artifacts may be combined with the glass frit prior to sprinkling on the first layer of glass or they may be sprinkled separately onto the first layer of glass. The glass frit and glass layers may be colored or clear. In an alternate embodiment, glass frit is not combined with the ashes or other artifacts, and only ash or artifacts are placed on the first layer of glass. Optimally, an artistic or aesthetically pleasing pattern is used in the sprinkling of the ashes or placing of the artifacts. Advantageously, the patterns are intended to create a fittingly beautiful piece of art or simply a meaningful reminder of the loved one.

In addition, other materials besides glass frit may be included in the layer containing just ash or ash and glass frit. Other materials which optionally are included in the layer with the ash are copper, brass, gold or silver, and glass chips and stringers, both plain and multicolored. Also, gold, silver or platinum paint, glassline and glassline paper are used. Optionally, any glass fusion (warm glass) product used in conjunction with ash fired within is used.

Advantageously, additional layers are added as background to the assembly before fusing. A single layer is added, if desired, by layering on material which will adher to the 2^{nd} layer of glass during the firing. For a decorative layer that will not by itself adher during firing, a third layer of glass is added onto the back of the decoration. The glass background can be clear or colored. This allows for the introduction, between the second and third layers of glass, of additional artifacts, background colors, further artwork or other such decorations, as well as adding depth to the display. Any of the materials mentioned above for inclusion with the ash layer are also optionally included in additional layers added as background.

In one embodiment, the disclosed method of fusing carbon containing artifacts in glass proceeds through the steps of: 1) taking a 1st layer of glass and sprinkling the 1st layer of glass with a 2^{nd} layer containing a quantity of glass frit and a quantity of carbon containing artifact; 2) covering the 2^{nd} layer with a 3^{rd} layer of glass; and 3) fusing the three layers at a temperature between 1420-1760 degrees Fahrenheit.

It is advantageous, during the step of fusing any disclosed combination of three layers, that the three layers are fused at a temperature of about 1700 degrees Fahrenheit.

Optionally, prior to the step of sprinkling the 2^{nd} layer onto the 1^{st} layer, the quantity of glass frit and quantity of carbon containing artifact are combined. Alternately, during the step of sprinkling the 2^{nd} layer onto the 1^{st} layer, the quantity of glass frit and the quantity of carbon containing artifact are sprinkled separately.

Optionally, the 1^{st} and 3^{rd} layers of glass are composed of dichroic glass.

After covering the 2^{nd} layer with a 3^{rd} layer of glass, and prior to fusing the three layers, a 4^{th} layer of an aesthetic decoration is optionally placed on the 3^{rd} layer of glass. Additionally, after the step of the 4^{th} layer of an aesthetic decoration being placed on the 3^{rd} layer of glass, and prior to fusing the three layers, a 5^{th} layer of glass is optionally placed covering the 4^{th} layer. In this embodiment, the 1^{st}, 3^{rd} and 5^{th} layers of glass are advantageously composed of dichroic glass.

In an alternate embodiment of the disclosed method of fusing carbon containing artifacts in glass, no glass frit is employed.

An apparatus for the display of carbon containing artifact in glass is also disclosed, the apparatus being a layer of carbon containing artifact fused between a 1^{st} layer of glass and a 2^{nd} layer of glass. Optionally, a quantity of glass frit is combined within the layer of carbon containing artifact. The 1^{st} layer of glass and the 2^{nd} layer of glass are optionally composed of dichroic glass. Advantageously, an additional layer of an aesthetic decoration is applied to the outside of the 2^{nd} layer of glass and, optionally, a 3^{rd} layer of glass is fused to the apparatus outside of the aesthetic decoration. In this case it is advantageous that all 3 layers of glass are composed of dichroic glass.

The resultant apparatus is, in a simple form, a layer of carbon containing artifact displayed between two fused layers of glass. An optional third layer of glass behind the second layer of glass adds apparent depth and provides a layer space for fusing in additional artwork or other aesthetics and decorations.

### BRIEF DESCRIPTION OF THE DRAWINGS

FIG. 1 is atop plan view of one embodiment of the disclosed apparatus created by the disclosed method.

FIG. 2 is a side elevation of a step in the disclosed process.

FIG. 3 is an exploded side elevation illustrating the separate components of one embodiment of the disclosed apparatus.

FIG. 4 is a side elevation of the finished product of one embodiment of the disclosed process.

FIG. 5 is a flowchart of one embodiment of the disclosed process.

### BEST MODE OF CARRYING OUT THE INVENTION

The disclosed apparatus and method are directed to the display of carbon containing artifacts, one of the most common of which are the cremated remains of departed loved ones and pets. The use of the term “ashes” herein refers not only to cremation ashes but to any carbon containing artifact or artifacts.

Turning now to the drawings, the invention will be described in a preferred embodiment by reference to the numerals of the drawing figures wherein like numbers indicate like parts.

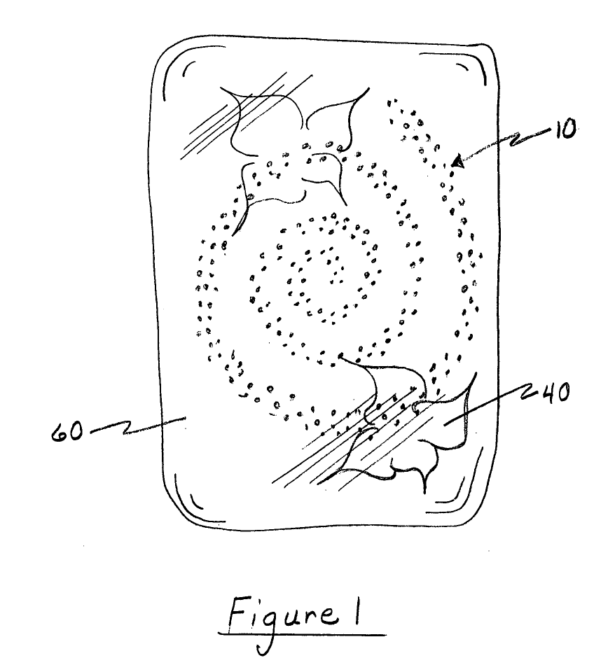

FIG. 1 illustrates one possible embodiment of finished product created by the disclosed method as seen by a viewer. In this embodiment, cremation ashes 10 have been laid out in a spiral pattern on a 1^{st} layer of glass. A background decoration 40, in this case a flower petal design, has been placed behind a 2^{nd} layer of glass and sealed in place by placement of a 3^{rd} layer of glass. All layers of glass have been fused into a single casing 60, preserving the artwork and protecting ashes 10.

In FIG. 2 is illustrated in a side elevation a step in the disclosed process whereby ashes 10 are sprinkled over a 1^{st} layer of glass 20.

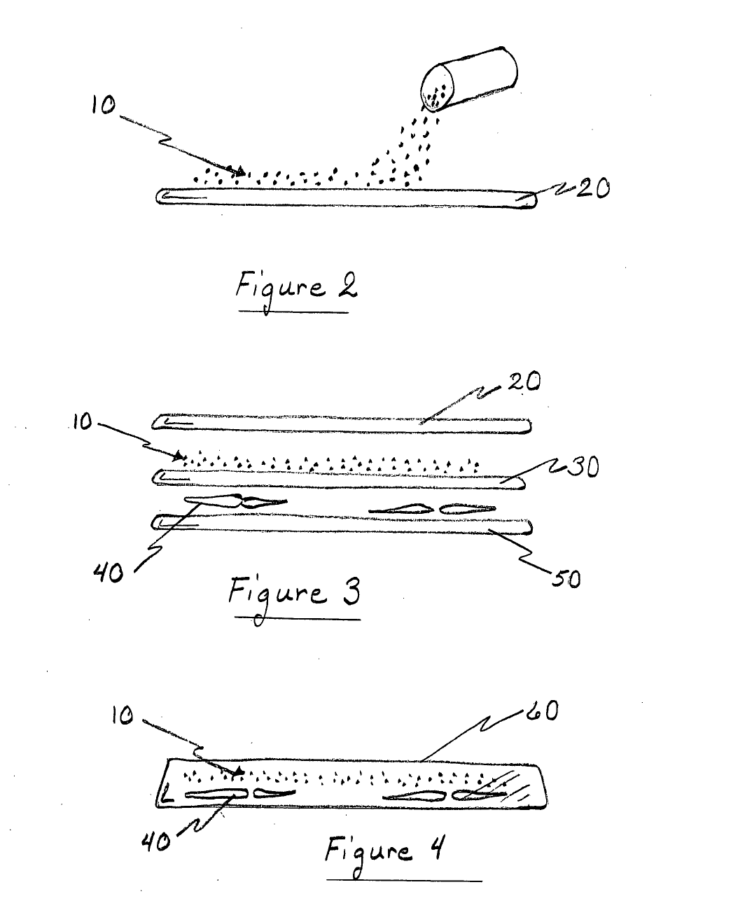

FIG. 3 is an exploded side elevation illustrating separate components of one embodiment of the disclosed apparatus. Prior to fusing, a 1^{st} layer of glass 20 covers cremation ashes 10. A 2^{nd} layer of glass 30 sandwiches ashes 10 between 2 layers of glass. In this embodiment, a decorative layer 40 has been added and a 3^{rd} layer of glass 50 seals decorative layer 40 against the assembly.

FIG. 4 is a side elevation of finished product of one embodiment of the disclosed process. 1^{st} glass layer 20, 2^{nd} glass layer 30 and 3^{rd} glass layer 50 have been fused into a single mass of glass, casing 60, with ashes 10 and decorative layer 40 held securely in the glass mass for display.

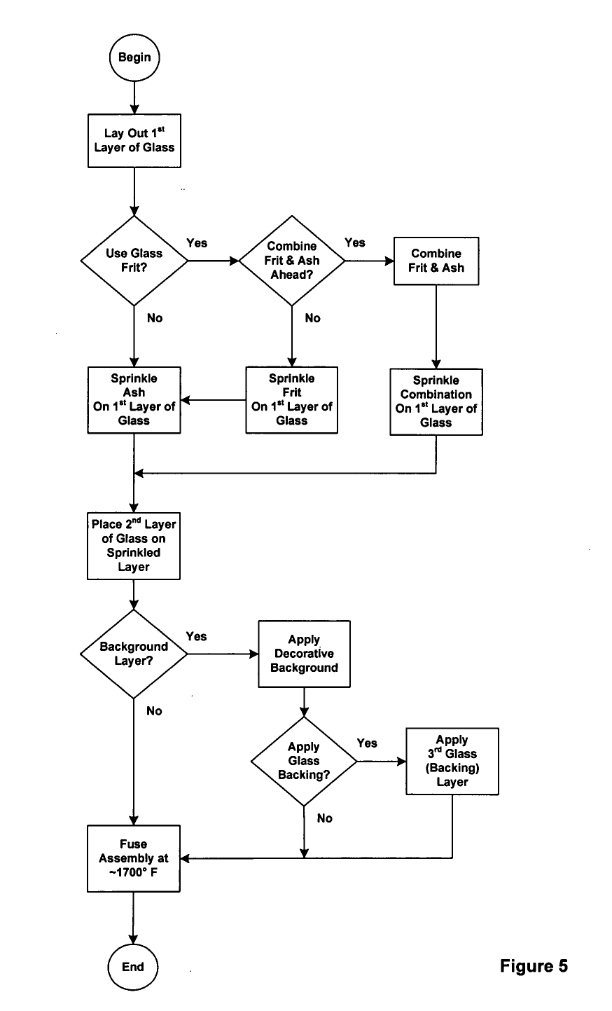

FIG. 5 is a flowchart of one embodiment of the disclosed process. To begin the artisan lays out a layer of glass. If glass frit is to be mixed with cremation ash or other carbon based artifact, it can either be combined with ash before sprinkling or sprinkled separately. Once ash, or an ash and frit combination, is sprinkled on a first layer of glass, a 2^{nd} layer of glass is placed on it. If a background layer is to be used, it is applied at this time. It is possible a background layer may be of such material as does not require a 3^{rd} layer of glass to be applied, such as in the case of a glaze, a glass powder or other decorations which will adher to the 2^{nd} glass layer during firing. Other decorations will require a 3^{rd} glass layer, a glass backing layer to incorporate them in the finished product. Once all desired components are assembled the assembly is fired at a temperature to accomplish fusing of the glass components, optimally, in the range of 1420-1760° F. An advantageous temperature is approximately 927° C. (1700° F.). The resultant product is a fused mass 60 of glass in which is displayed cremation ashes 10 or other carbon based artifacts.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

### INDUSTRIAL APPLICABILITY

The disclosed method and apparatus provides an advantageous option for preserving carbon based artifacts of departed loved ones such as cremation ash, one which combines security with a plethora of aesthetically pleasing display possibilities. The disclosed method has overcome the difficulty of bubbles appearing within the display and provides a display where artifacts may be clearly viewed and recognized.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A method of fusing carbon containing artifacts in glass, the method comprising the steps of:
a. taking a 1^{st} layer of glass and sprinkling the 1^{st} layer of glass with a 2^{nd} layer, the 2^{nd} layer comprising a quantity of glass frit and a quantity of carbon containing artifact,
b. covering the 2^{nd} layer with a 3^{rd} layer of glass, and
c. fusing the three layers at a temperature between 1420-1760 degrees Fahrenheit.

2. The method of claim 1 where, in step 1.c, the three layers are fused at a temperature of about 1700 degrees Fahrenheit.

3. The method of claim 1 where, prior to step 1.a, the quantity of glass frit and quantity of carbon containing artifact are combined.

4. The method of claim 1 where, in step 1.a, the quantity of glass frit and the quantity of carbon containing artifact are sprinkled separately.

5. The method of claim 1 wherein, the 1^{st} layer of glass and the 3^{rd} layer of glass are composed of dichroic glass.

6. The method of claim 1 where, after step 1.b and prior to step 1.c, a 4^{th} layer comprising an aesthetic decoration is placed on the 3^{rd} layer of glass.

7. The method of claim 6 where, after the step of the 4^{th} layer comprising an aesthetic decoration being placed on the 3^{rd} layer of glass and prior to step 1.c, a 5^{th} layer of glass is placed covering the 4^{th} layer.

8. The method of claim 7 wherein, the 1^{st} layer of glass, the 3^{rd} layer of glass and the 5^{th} layer of glass are composed of dichroic glass.

9. A method of fusing carbon containing artifacts in glass, the method comprising the steps of:
a. taking a 1^{st}, layer of glass and sprinkling the 1^{st} layer of glass with a 2^{nd} layer, the 2^{nd} layer consisting of a quantity of carbon containing artifact,
b. covering the 2^{nd} layer with a 3^{rd} layer of glass, and
c. fusing the three layers at a temperature between 1420-1760 degrees Fahrenheit.

10. The method of claim 9 where, in step 9.c, the three layers are fused at a temperature of about 1700 degrees Fahrenheit.

11. The method of claim 9 wherein, the 1^{st} layer of glass and the 3^{rd} layer of glass are composed of dichroic glass.

12. The method of claim 9 where, after step 9.b and prior to step 9.c, a 4^{th} layer comprising an aesthetic decoration is placed on the 3^{rd} layer of glass.

13. The method of claim 12 where, after the step of the 4^{th} layer comprising an aesthetic decoration being placed on the 3^{rd} layer of glass and prior to step 9.c, a 5^{th} layer of glass is placed covering the 4^{th} layer.

14. The method of claim 13 wherein, the 1^{st} layer of glass, the 3^{rd} layer of glass and the 5^{th} layer of glass are composed of dichroic glass.

15. An apparatus for the display of carbon containing artifact in glass, the apparatus comprising a layer of carbon containing artifact fused between a 1^{st} layer of glass and a 2^{nd} layer of glass.

16. The Apparatus of claim 15 further comprising a quantity of glass frit combined within the layer of carbon containing artifact.

17. The Apparatus of claim 15 in which the 2 layers of glass are composed of dichroic glass.

18. The Apparatus of claim 15 further comprising an additional layer of an aesthetic decoration applied to the outside of the 2^{nd} layer of glass.

19. The Apparatus of claim 18 further comprising a 3^{rd} layer of glass fused to the apparatus outside of the aesthetic decoration.

20. The Apparatus of claim 19 in which the 3 layers of glass are composed of dichroic glass.
